(19) United States
(12) Patent Application Publication
(10) Pub. No.: US 2022/0126129 A1
(43) Pub. Date: Apr. 28, 2022

(54) FACE MASK COVER

(71) Applicant: Alpine Innovations LLC, Lehi, UT (US)

(72) Inventor: Darren Jones, American Fork, UT (US)

(73) Assignee: Alpine Innovations LLC, Lehi, UT (US)

(21) Appl. No.: 17/213,694

(22) Filed: Mar. 26, 2021

Related U.S. Application Data
(60) Provisional application No. 63/105,797, filed on Oct. 26, 2020.

(51) Int. Cl. A62B 18/08; A41D 13/11; A62B 23/02

(52) U.S. Cl. CPC A62B 18/084; A62B 23/025; A41D 13/1161

(57) ABSTRACT

Technology for a face mask is disclosed. The face mask can comprise a fabric cover operable to engage at least a portion of a user's face. The fabric cover can comprise: a first top corner, a second top corner, a first bottom corner, a second bottom corner, an inner surface, and an outer surface. The face mask can comprise one or more straps operable to engage the fabric cover over the portion of the user's face. The strap can be coupled to the first top corner, the second top corner, the first bottom corner, and the second bottom corner. The strap can be operable to engage around ears of the user and around a neck of the user.

### RELATED APPLICATIONS

This application claims priority to U.S. Provisional Patent Application No. 63/105,797, filed Oct. 26, 2020, which is incorporated herein by reference.

### BACKGROUND

Face masks can be used as public and personal health control measures against the spread of disease. The use of face masks has been recommended by health officials to minimize the risk of infections. Different types of face masks can include cloth masks, surgical masks, filtering facepiece respirators, powered air-purifying respirators, face shields, and eye protection. However, face mask shortages have occurred, which has led to substandard masks entering the market with reduced performance in slowing the spread of disease.

### BRIEF DESCRIPTION OF THE DRAWINGS

Features and advantages of technology embodiments will be apparent from the detailed description which follows, taken in conjunction with the accompanying drawings, which together illustrate, by way of example, various technology features; and, wherein:

FIG. 1 illustrates a face mask in accordance with an example;

FIG. 2a illustrates a front view of a face mask in accordance with an example;

FIG. 2b illustrates a side view of a face mask in accordance with an example;

FIG. 3 illustrates a face mask in accordance with an example;

FIG. 4 illustrates a face mask in accordance with an example;

FIG. 5a illustrates a front view of a face mask in accordance with an example;

FIG. 5b illustrates a side view of a face mask in accordance with an example;

FIG. 6 illustrates a face mask and a filter in accordance with an example;

FIG. 7a illustrates a front view of a face mask in a covering orientation in accordance with an example;

Example 7b illustrates a front view of a face mask in a hang orientation in accordance with an example; and

FIG. 8 depicts functionality for securing a mask over a user's face in accordance with an example.

Reference will now be made to the exemplary embodiments illustrated, and specific language will be used herein to describe the same. It will nevertheless be understood that no limitation on technology scope is thereby intended.

### DESCRIPTION OF EMBODIMENTS

Before the disclosed technology embodiments are described, it is to be understood that this disclosure is not limited to the particular structures, process steps, or materials disclosed herein, but is extended to equivalents thereof as would be recognized by those ordinarily skilled in the relevant arts. It should also be understood that terminology employed herein is used for the purpose of describing particular examples or embodiments only and is not intended to be limiting. The same reference numerals in different drawings represent the same element. Numbers provided in flow charts and processes are provided for clarity in illustrating steps and operations and do not necessarily indicate a particular order or sequence.

### DEFINITIONS

As used in this written description, the singular forms “a,” “an” and “the” include express support for plural referents unless the context clearly dictates otherwise.

Reference throughout this specification to “an example” means that a particular feature, structure, or characteristic described in connection with the example is included in at least one embodiment of the present invention. Thus, appearances of the phrases “in an example” or “an embodiment” in various places throughout this specification are not necessarily all referring to the same embodiment.

As used herein, a plurality of items, structural elements, compositional elements, and/or materials can be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present technology can be referred to herein along with alternatives for the various components thereof. It is understood that such embodiments, examples, and alternatives are not to be construed as de facto equivalents of one another, but are to be considered as separate and autonomous representations under the present disclosure.

Furthermore, the described features, structures, or characteristics can be combined in any suitable manner in one or more embodiments. In the following description, numerous specific details are provided, such as examples of layouts, distances, network examples, etc., to provide a thorough understanding of invention embodiments. One skilled in the relevant art will recognize, however, that the technology can be practiced without one or more of the specific details, or with other methods, components, layouts, etc. In other instances, well-known structures, materials, or operations may not be shown or described in detail to avoid obscuring aspects of the disclosure.

In this disclosure, “comprises,” “comprising,” “containing” and “having” and the like can have the meaning ascribed to them in U.S. Patent law and can mean “includes,” “including,” and the like, and are generally interpreted to be open ended terms. The terms “consisting of” or “consists of” are closed terms, and include only the components, structures, steps, or the like specifically listed in conjunction with such terms, as well as that which is in accordance with U.S. Patent law. “Consisting essentially of” or “consists essentially of” have the meaning generally ascribed to them by U.S. Patent law. In particular, such terms are generally closed terms, with the exception of allowing inclusion of additional items, materials, components, steps, or elements, that do not materially affect the basic and novel characteristics or function of the item(s) used in connection therewith. For example, trace elements present in a composition, but not affecting the compositions nature or characteristics would be permissible if present under the “consisting essentially of” language, even though not expressly recited in a list of items following such terminology. When using an open-ended term in this written description, like “comprising” or “including,” it is understood that direct support should be afforded also to “consisting essentially of” language as well as “consisting of” language as if stated explicitly and vice versa.

The terms “first,” “second,” “third,” “fourth,” and the like in the description and in the claims, if any, are used for distinguishing between similar elements and not necessarily for describing a particular sequential or chronological order. It is to be understood that any terms so used are interchangeable under appropriate circumstances such that the embodiments described herein are, for example, capable of operation in sequences other than those illustrated or otherwise described herein. Similarly, if a method is described herein as comprising a series of steps, the order of such steps as presented herein is not necessarily the only order in which such steps may be performed, and certain of the stated steps may possibly be omitted and/or certain other steps not described herein may possibly be added to the method.

The terms “coupled” and “connected” can be used interchangeably and refer to a relationship between items or structures that are either directly or indirectly connected in an electrical or nonelectrical manner. “Directly coupled” or “directly connected” objects or elements are in physical contact with one another. In this written description, recitation of “coupled” or “connected” provides express support for “directly coupled” or “directly connected” and vice versa. Objects described herein as being “adjacent to” each other may be in physical contact with each other, in close proximity to each other, or in the same general region or area as each other, as appropriate for the context in which the phrase is used.

Occurrences of the phrase “in one embodiment,” or “in one aspect,” herein do not necessarily all refer to the same embodiment or aspect.

As used herein, comparative terms such as “increased,” “decreased,” “better,” “worse,” “higher,” “lower,” “enhanced,” “maximized,” “minimized,” and the like refer to a property of a device, component, or activity that is measurably different from other devices, components, or activities in a surrounding or adjacent area, in a single device or in multiple comparable devices, in a group or class, in multiple groups or classes, or as compared to the known state of the art.

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result. For example, a composition that is “substantially free of” particles would either completely lack particles, or so nearly completely lack particles that the effect would be the same as if it completely lacked particles. In other words, a composition that is “substantially free of” an ingredient or element may still actually contain such item as long as there is no measurable effect thereof.

As used herein, the term “about” is used to provide flexibility to a numerical range endpoint by providing that a given value may be “a little above” or “a little below” the endpoint. However, it is to be understood that even when the term “about” is used in the present specification in connection with a specific numerical value, that support for the exact numerical value recited apart from the “about” terminology is also provided.

Numerical amounts and data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3, and 4 and sub-ranges such as from 1-3, from 2-4, and from 3-5, etc., as well as 1, 1.5, 2, 2.3, 3, 3.8, 4, 4.6, 5, and 5.1 individually.

This same principle applies to ranges reciting only one numerical value as a minimum or a maximum. Furthermore, such an interpretation should apply regardless of the breadth of the range or the characteristics being described.

### DESCRIPTION

An initial overview of technology embodiments is provided below and then specific technology embodiments are described in further detail later. This initial summary is intended to aid readers in understanding the technology more quickly, but is not intended to identify key or essential technological features nor is it intended to limit the scope of the claimed subject matter. Unless defined otherwise, all technical and scientific terms used herein have the same meaning as commonly understood by one of ordinary skill in the art to which this disclosure belongs.

Various types of face masks can be used to attempt to prevent the spread of diseases including: cloth masks, surgical masks, filtering facepiece respirators, powered air-purifying respirators, face shields, and eye protection. Because of the expense and unavailability of some of these face masks (e.g., powered air-purifying respirators), it is not be practical to use a mask that perfectly filters all known pathogens and toxins at all times at a low cost.

Cloth face masks can be used by users who appear healthy to prevent the spread of diseases for various reasons including asymptomatic transmission and impracticable social distancing. However, face masks are as effective in preventing diseases as the prevalence of their use. Face masks are less effective in public settings particularly when the face mask is difficult to fit properly onto the face of a user or when the face mask is difficult to remove from user's face or to attach to a user's face. A face mask that can be easily coupled or uncoupled from a user's face while preserving a simple design can reduce the reluctance in face mask use among the public. A face mask with an adjustable fit can also enhance the benefits associated with face mask use.

In one embodiment, a face mask can include a fabric cover operable to engage at least a portion of a user's face. In one aspect, the fabric cover can include a first top corner, a second top corner, a first bottom corner, and a second bottom corner. In another aspect, the face mask can include an inner surface and an outer surface. In another aspect, the face mask can include a strap operable to engage the fabric cover over the portion of the user's face. In one example, the strap can be coupled to the first top corner and the second top corner. In this example, the strap can be engaged to the first bottom corner and the second bottom corner. In this example, the strap can be operable to engage around ears of the user and around a neck of the user.

In another embodiment, a method of securing a mask over a user's face can include coupling a strap to a first top corner, a second top corner, a first bottom corner, and a second bottom corner of a fabric cover of the mask. In one aspect, the method can comprise engaging the strap around ears of the user and around a neck of the user. In another aspect, the method can comprise securing the fabric cover over the user's face.

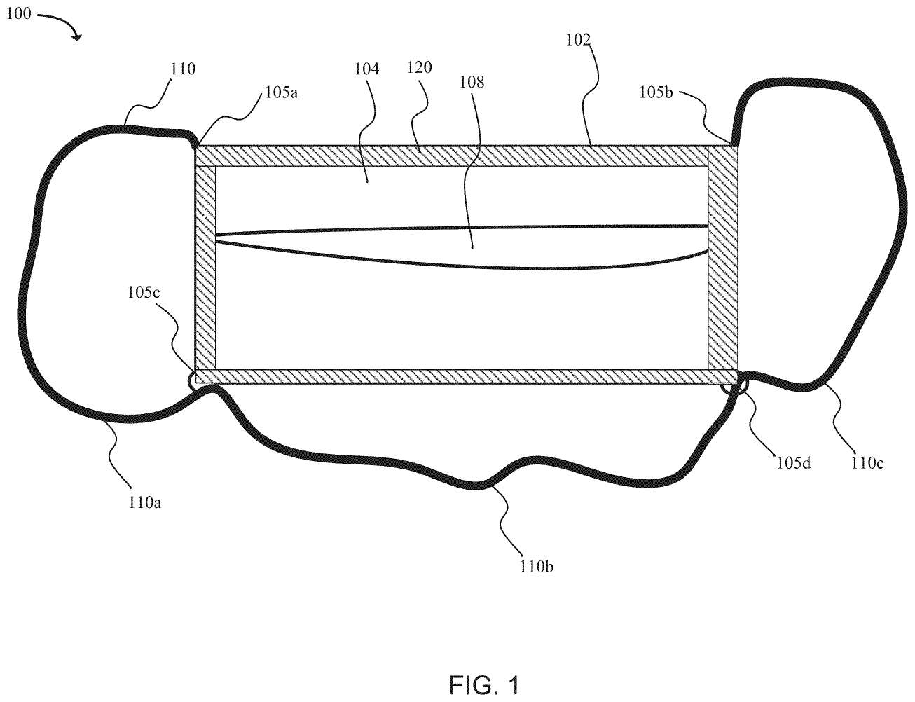

In one embodiment, as illustrated in FIG. 1, a face mask 100 can include a fabric cover 102 operable to engage at least a portion of a user's face, wherein the fabric cover 102 includes a first top corner 105a, a second top corner 105b, a first bottom corner 105c, and a second bottom corner 105d. In one aspect, the face mask can include an inner surface 104 and an outer surface on an opposite side of the inner surface 104. In one example, the face mask 100 can include a strap 110 operable to engage the fabric cover 102 over the portion of the user's face. In one aspect, the strap can be coupled (e.g., fixedly attached) to the first top corner 105a and the second top corner 105b. In another aspect, the strap can be coupled (e.g., engaged) to the first bottom corner 105c and the second bottom corner 105d. In another aspect, the strap 110 can be operable to engage around ears of the user and around a neck of the user.

In one aspect, the strap 110 can include a first portion 110a that can be fixedly attached to the first top corner 105a and engaged to the first bottom corner 105c. The first portion 110a of the strap 110 can be operable to engage around a first ear of the user. The second portion 110c of the strap 110 can be fixedly attached to the second top corner 105b and engaged to the second bottom corner 105d. The second portion 110c of the strap can be operable to engage around a second ear of the user. The middle portion 110b of the strap 110 can be engaged to the first bottom corner 105c and the second bottom corner 105d. The middle portion 110b of the strap 110 can be operable to engage around the neck of the user.

In another aspect, the face mask 100 can be operable to hang from the neck of the user by the middle portion 110b of the strap 110 when the first portion 110a of the strap 110 is not engaged around the first ear of the user, the second portion 110c of the strap 110 is not engaged around the second ear of the user, and the middle portion 110b of the strap 110 is engaged around the neck of the user.

In another aspect, the face mask 100 can include an inner surface 104 that can include a pocket 108 that can be operable to retain a filter. In another aspect, the fabric cover 102 can include an antimicrobial material including one or more of: silver-infused fabrics, silver compound infused fabrics, silver-oxide infused fabrics, zinc-oxide infused fabrics, titanium dioxide infused fabrics, aluminum infused fabrics, aluminum oxide infused fabrics, copper infused fabrics, copper oxide infused fabrics, and combinations thereof.

In another aspect, the face mask 100 can include a border 120 that can circumscribe the fabric cover 102. In one example, the border can have a top portion that couples the first top corner 105a to the second top corner 105b. The border can have a first side portion that couples the first top corner 105a to the first bottom corner 105c. The border can have a second side portion that couples the second top corner 105b to the second bottom corner 105d. The border can have a bottom portion that couples the first bottom corner 105c to the second bottom corner 105d.

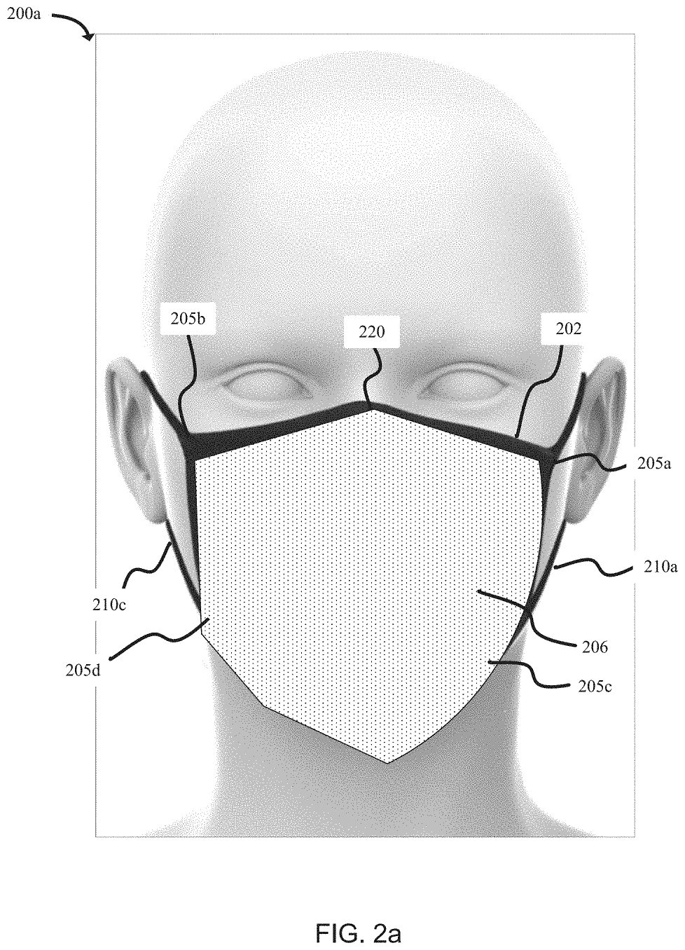

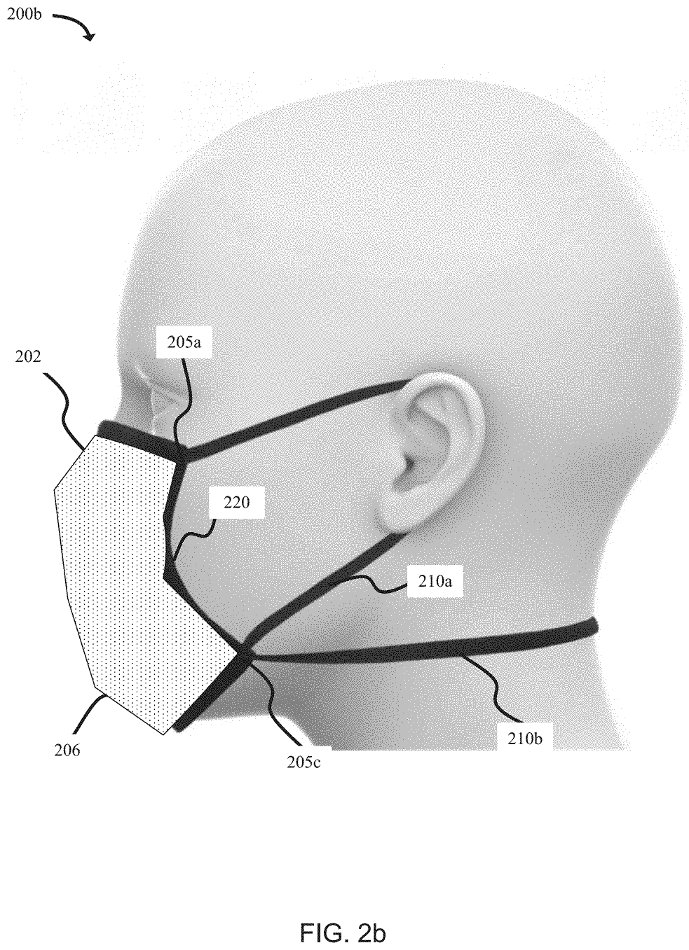

In another example, as illustrated in FIG. 2a, a face mask 200a can include a border 220 that includes a first top corner 205a, a second top corner 205b, a first bottom corner 205c, and a second bottom corner 205d. The border 220 can circumscribe the fabric cover 202. The outer surface 206 of the fabric cover 202 can include an antimicrobial material including one or more of: silver-infused fabrics, silver compound infused fabrics, silver-oxide infused fabrics, zinc-oxide infused fabrics, titanium dioxide infused fabrics, aluminum infused fabrics, aluminum oxide infused fabrics, copper infused fabrics, copper oxide infused fabrics, and combinations thereof.

In one aspect, the first top corner 205a can be fixedly attached to a first portion 210a of a strap and the second top corner 205b can be fixedly attached to a second portion 210c of the strap. The first portion 210a of the strap can be movably engaged with the first bottom corner 205c using a retainer such as a loop (e.g., a fabric or plastic loop), a clip, or other retainer. The second portion 210c of the strap can be movably engaged with the second bottom corner 205d using a retainer such as a loop (e.g., a fabric or plastic loop), a clip, or other retainer. the like, and combinations thereof.

In another aspect, as illustrated in FIG. 2b, a face mask 200b can include a middle portion 210b of the strap that is movably engaged with each of the first bottom corner 205c and the second bottom corner 205d using a loop, such as a fabric or plastic loop, a clip, or other retainer.

In another example, the border 220 can be configured to provide an airtight seal between the face cover 202 and a face of a user. In one aspect, the top portion of the border 220 can be directly coupled between the first top corner 205a and the second top corner 205b. The top portion of the border 220 can include a pliable material that can retain a shape that can provide a seal around a bridge of a nose of a user.

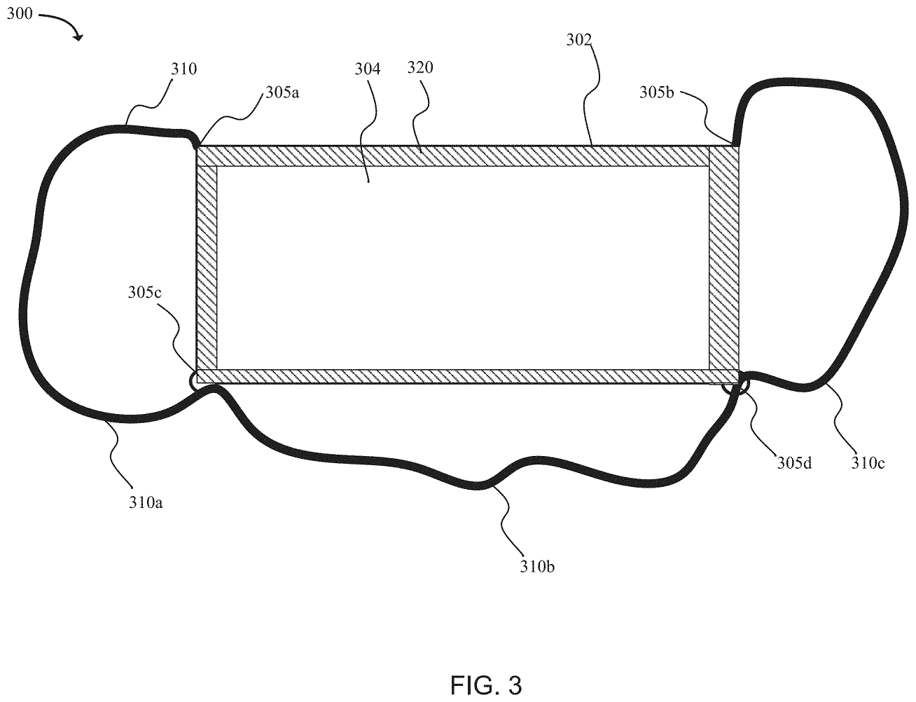

In another example, as illustrated in FIG. 3, a face mask 300 can include a fabric cover 302 having an inner surface 304, a border 320, and an outer surface (not shown) on an opposite side of the inner surface. In some examples, the inner surface 304 and the outer surface can be the same fabric on opposite sides. In another example, the inner surface 304 and the outer surface can be separate fabrics that can comprise the same fabric material or different fabric materials. In another example, additional fabrics can be included between an inner surface 304 and an outer surface. The additional fabrics between the inner surface 304 and the outer surface can provide additional filtering. In one example, one fabric can be inserted between the inner surface and the outer surface to provide a total of three layers of fabric. Thus, the fabric cover can comprise a plurality of layers, which can each be comprised of the same fabric material or of different fabric materials.

In one aspect, the inner surface or the outer surface 304 of the fabric cover 302 can include an antimicrobial material including one or more of: silver-infused fabrics, silver compound infused fabrics, silver-oxide infused fabrics, zinc-oxide infused fabrics, titanium dioxide infused fabrics, aluminum infused fabrics, aluminum oxide infused fabrics, copper infused fabrics, copper oxide infused fabrics, and combinations thereof.

In one aspect, the face cover 302 can form a pocket 308 that can be operable to retain a filter. The pocket 308 can be formed to retain the filter on an inner surface of the fabric cover 302. The filter can be configured to filter pathogens that are physically proximate to a user. In some aspects, pathogens can be physically proximate to a user when the pathogens can be communicated from another user that is within a physical proximity of less than 10 m, 5 m, 3 m, 2 m, or 1 m, the like, and combinations thereof. In one aspect, the pathogens can include one or more of: bacteria, viruses, protozoa, fungi, the like, and combinations thereof. In another example, the filter can be configured to filter toxins including one or more of biological toxins, chemical toxins, physical toxins, and radiative toxins.

In one aspect, the first top corner 305a can be fixedly attached to a first portion 310a of a strap 310 and the second top corner 305b can be fixedly attached to a second portion 310c of the strap 310. The first portion 310a of the strap 310 can be movably engaged with the first bottom corner 305c using a retainer such as a loop (e.g. a fabric or plastic loop), a clip, or other retainer. The second portion 310c of the strap 310 can be movably engaged with the second bottom corner 305d using a retainer such as a loop (e.g., a fabric or plastic loop), a clip, or other retainer. The face mask 300 can include a middle portion 310b of the strap 310 that can be movably engaged with each of the first bottom corner 305c and the second bottom corner 305d using one or more retainers such as a loop (e.g., a fabric or plastic loop), a clip, or other retainer.

In one aspect, the length of the middle portion 310b of the strap 310 can be adjustable based on the length of the first portion 310a, the length of the second portion 310c, or both. In one example, the length of the middle portion 310b can be increased by moving the first portion 310a of the strap 310 through the first bottom corner 305c by also decreasing the length of the first portion 310a. In one example, the length of the middle portion 310b can be increased by moving the second portion 310c of the strap 310 through the second bottom corner 305d by also decreasing the length of the second portion 310c.

In one aspect, the length of the first portion 310a of the strap 310 can be adjustable based on the length of the second portion 310c. In one example, the length of the first portion 310a can be increased by moving the middle portion 310b of the strap 310 through the first bottom corner 305c by also decreasing the length of the middle portion 310b. In another aspect, the length of the second portion 310c of the strap 310 can be adjustable based on the length of the middle portion 310b. In one example, the length of the second portion 310c can be increased by moving the middle portion 310b of the strap 310 through the second bottom corner 305d by also decreasing the length of the middle portion 310b. In one aspect, the first portion 310a or second portion 310c of the strap 310 can be operable to engage around an ear of the user by looping around the ear of the user. In another aspect, the length of the first portion 310a or the second portion 310c of the strap 310 can be operable to be adjusted around the ear of the user.

In one aspect, the middle portion 310b of the strap 310 can be adjusted to fit a neck of a user. In another aspect, the first portion 310a of the strap 310 or the second portion 310c of the strap can be adjusted to fit around an ear of the user. In one aspect, the strap 310 can comprise a material (e.g. an elastic material) that can flexibly accommodate the ears and neck of the user. In some aspects, the first portion 310a of the strap can partially comprise a material that differs from the material of the middle portion 310b of the strap. In one example, the first portion 310a can have an elasticity that is higher than the elasticity of the middle portion 310b of the strap to enable adjustments around an ear of the user without sacrificing the tightness of the fit around an ear of the user. In another example, the second portion 310c can have an elasticity that is higher than the elasticity of the middle portion 310b of the strap to enable adjustments around an ear of the user without sacrificing the tightness of the fit around an ear of the user.

In another example, the middle portion 310b can have an elasticity that is lower than the elasticity of the first portion 310a or the second portion 310c to enable the mask to hang downward from the user when not in use without hanging tightly around a neck of the user.

In another aspect, the strap 310 can be an integrated material that is not comprised of a plurality of separate straps. In this example, each of the first portion 310a of the strap, the middle portion 310b of the strap, and the second portion 310c of the strap can be operable to change in length based on the length of the other two portions.

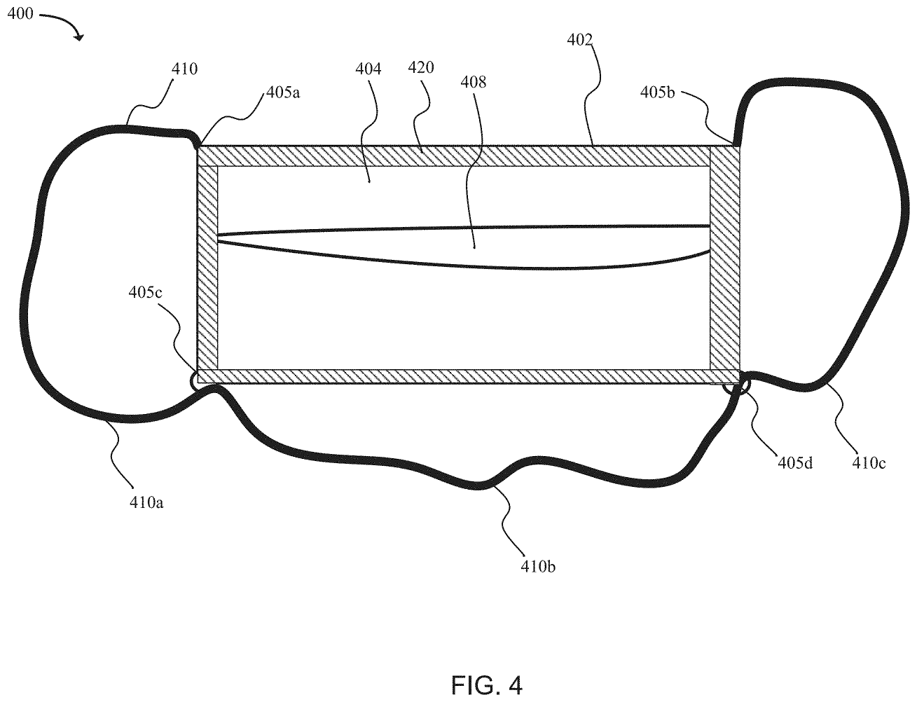

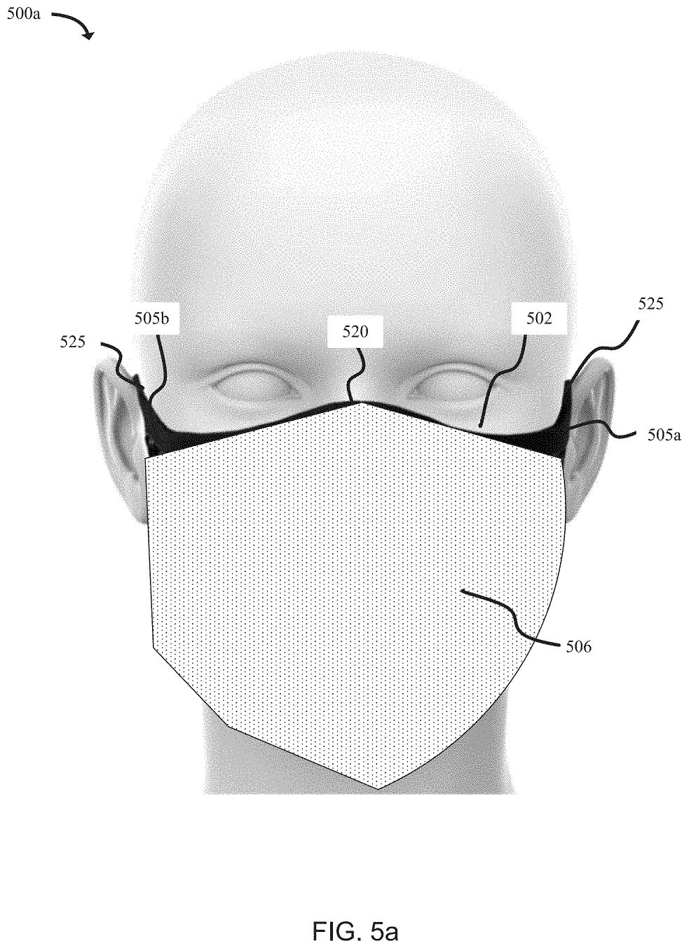

In another example, as illustrated in FIG. 4, a face mask 400 can include a fabric cover 402 having an inner surface 404, a pocket 408, a border 420, and an outer surface (not shown) on an opposite side of the inner surface 404. In one aspect, the first top corner 405a can be fixedly attached to a first portion 410a of a strap 410 and the second top corner 405b can be fixedly attached to a second portion 410c of the strap 410. The first portion 410a of the strap 410 can be movably engaged with the first bottom corner 405c using a retainer such as a loop (e.g., a fabric or plastic loop), a clip, or other retainer. The second portion 410c of the strap 410 can be movably engaged with the second bottom corner 405d using a retainer such as a loop (e.g., a fabric or plastic loop), a clip, or other retainer. The face mask 400 can include a middle portion 410b of the strap 410 that can be movably engaged with each of the first bottom corner 405c and the second bottom corner 405d using one or more retainers such as a loop(e.g., a fabric or plastic loop), a clip, or other retainer.

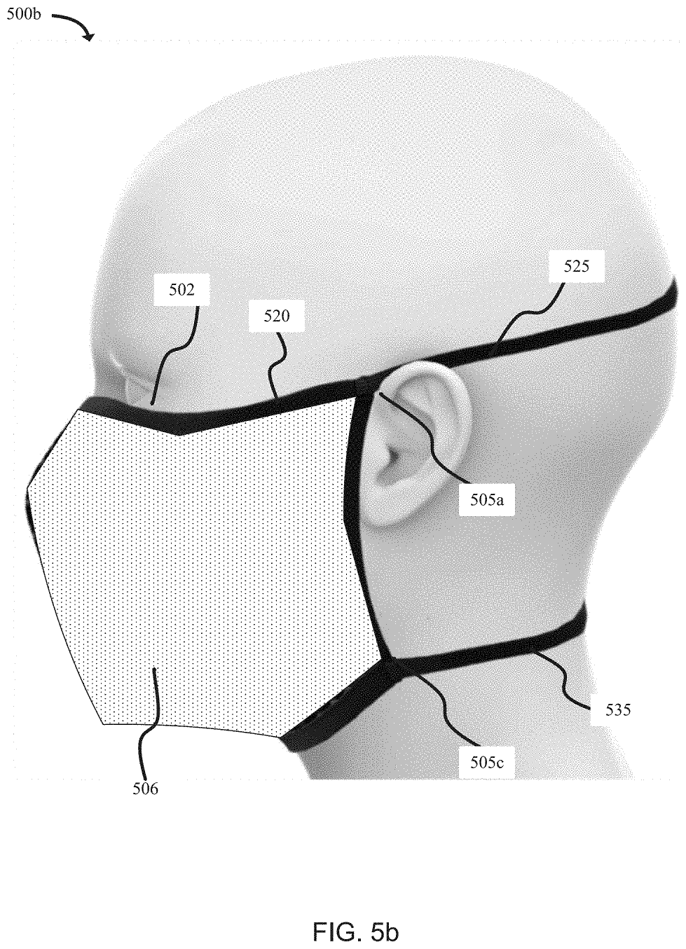

In another example, as illustrated in FIGS. 5a and 5b, a face mask 500a can include a fabric cover 502 operable to engage at least a portion of a user's face. The fabric cover 502 can include a first top corner 505a and a second top corner 505b, a first bottom corner 505c and a second bottom corner (not shown). The fabric cover 502 can include an outer surface 506 and an inner surface (not shown) that can include a pocket operable to retain a filter. The pocket can include a filter configured to filter pathogens that are proximate to a user.

In one aspect, the face mask 500a can include one or more straps 525 and 535 operable to engage the fabric cover 502 over the portion of the user's face. In one aspect, the one or more straps 525 and 535 include a first strap 525 operable to engage over a head of a user and a second strap 535 operable to engage around a neck of the user.

In one aspect, the fabric cover 502 can comprise an antimicrobial material including one or more of: silver-infused fabrics, silver compound infused fabrics, silver-oxide infused fabrics, zinc-oxide infused fabrics, titanium dioxide infused fabrics, aluminum infused fabrics, aluminum oxide infused fabrics, copper infused fabrics, copper oxide infused fabrics, and combinations thereof.

In one aspect, the one or more straps can include a first strap 525 that can be fixedly attached to the first top corner 505a and the second top corner 505b. The first strap 535 can be engaged to the first bottom corner 505c and the second bottom corner (not shown). The first strap can be operable to engage around the ears of the user and the second strap 535 can be operable to engage around a neck of the user.

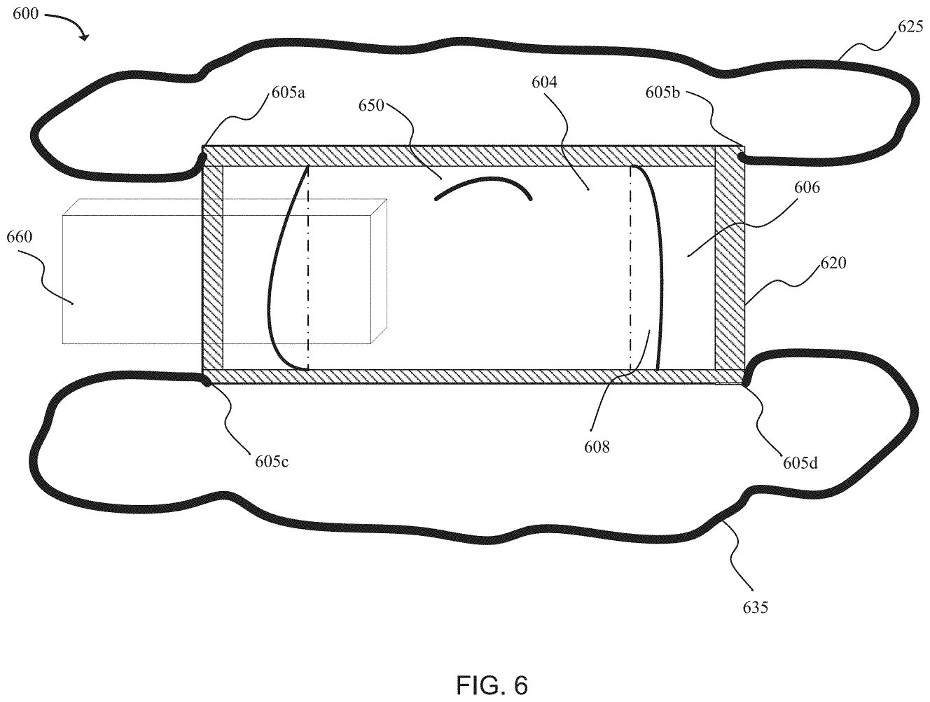

In another example, as illustrated in FIG. 6, a face mask 600 can include a first top corner 605a, a second top corner 605b, a first bottom corner 605c, and a second bottom corner 605d. The face mask 600 can include an inner fabric 604 with an inner surface that faces a user and an outer surface that face away from the user. The face mask 600 can include an outer fabric 606 that can include an inner surface that can face a user and an outer surface that can face away from a user. In one aspect, the number of fabrics can be 1, wherein the inner surface of the fabric faces the user and the outer surface of the same fabric faces away from the user. In another aspect, the number of fabrics can be 3, wherein an inner fabric is directly adjacent to the user, a middle fabric is directly adjacent to the inner fabric, and an outer fabric is directly adjacent to the middle fabric. The number of separate fabrics in the face mask can be increased or decreased based on the desired filtration properties of the face mask. In one aspect, the outer fabric 606 can comprise polyester fabric and the inner fabric 604 can comprise an antimicrobial fabric. In another aspect, the outer fabric 606 and the inner fabric 604 can form a pouch 608 that can retain a filter 660.

In one aspect, the face mask 600 can include a first strap 625 and a second strap 635. In another aspect, the fabric cover can include a border 620 that can circumscribe the inner fabric 604, the outer fabric 606, both, or any additional fabrics between an inner fabric 604 and an outer fabric 606.

In one aspect, the border 620 can be configured to provide an airtight seal between the face cover and a face of a user. In one aspect, the top border can include a pliable material that can retain a shape 650 that can provide a seal around a bride of a nose of a user.

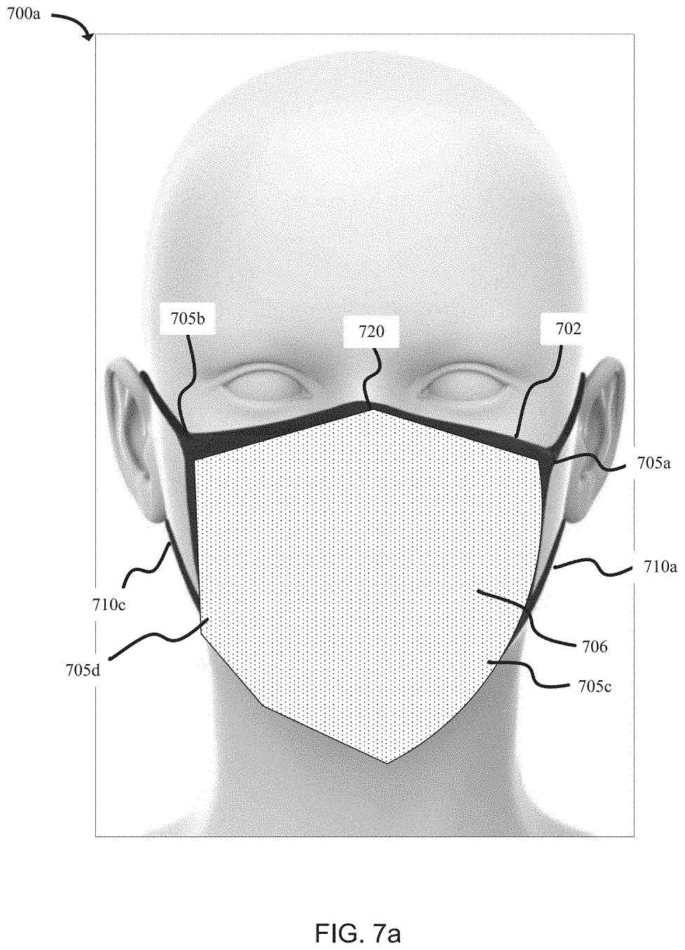

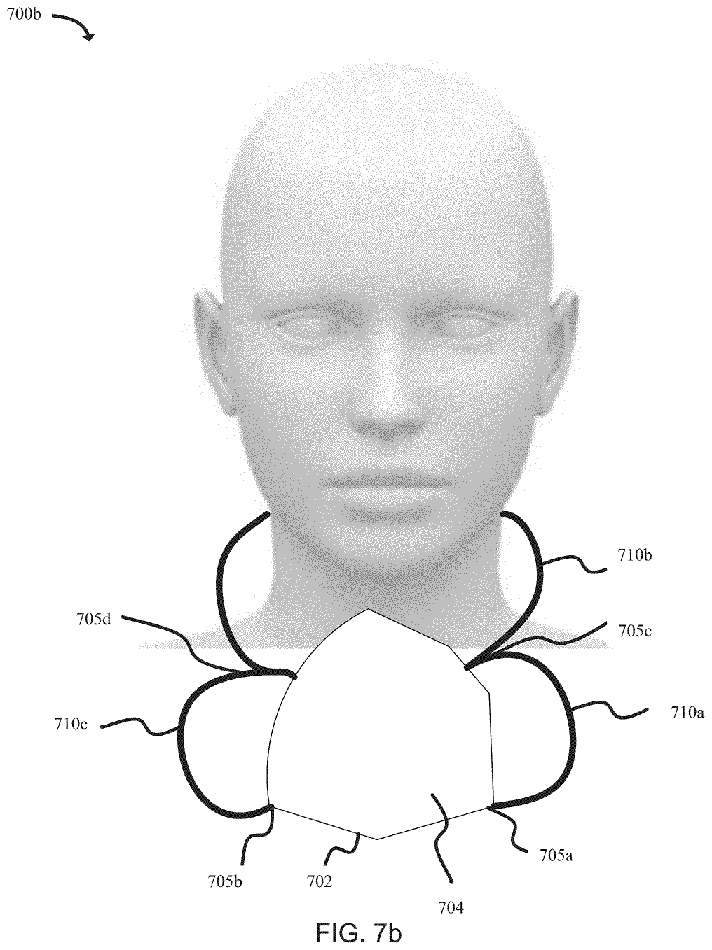

In another example, as illustrated in FIGS. 7a and 7b, a face mask 700a, 700b can comprise a fabric cover 702. The fabric cover can include a first top corner 705a, a second top corner 705b, a first bottom corner 705c, and a second bottom corner 705d. The fabric cover can include a border 720 that can be configured to provide an airtight seal between the face cover and a face of the user. The face mask can include an inner surface 704 and an outer surface 706. In one aspect, the face mask 700a, 700b can include a first portion 710a of a strap, a second portion 710c of the strap, and a middle portion 710b of the strap.

In one example, the fabric cover 702 can be operable to transition from a covering orientation (e.g., in FIG. 7a) to a hanging orientation (e.g., in FIG. 7b) when a first portion 710a of the strap is removed from a first ear of the user and a second portion 710c of the strap is removed from a second ear of the user. In another example, the fabric cover 702 can be operable to transition from a hanging orientation (e.g., in FIG. 7b) to a covering orientation (e.g., in FIG. 7a) when a first portion 710a of the strap is engaged around a first ear of the user and a second portion (710c) of the strap is engaged around a second ear of the user. In both the covering orientation and the handing orientation, the middle portion 710b of the strap can be engaged around a neck of the user. In the covering orientation, the fabric cover can be operable to cover a nose and a mouth of a user. In the hanging orientation, the fabric cover can be operable to hang around a neck of the user without covering the nose and the mouth of the user.

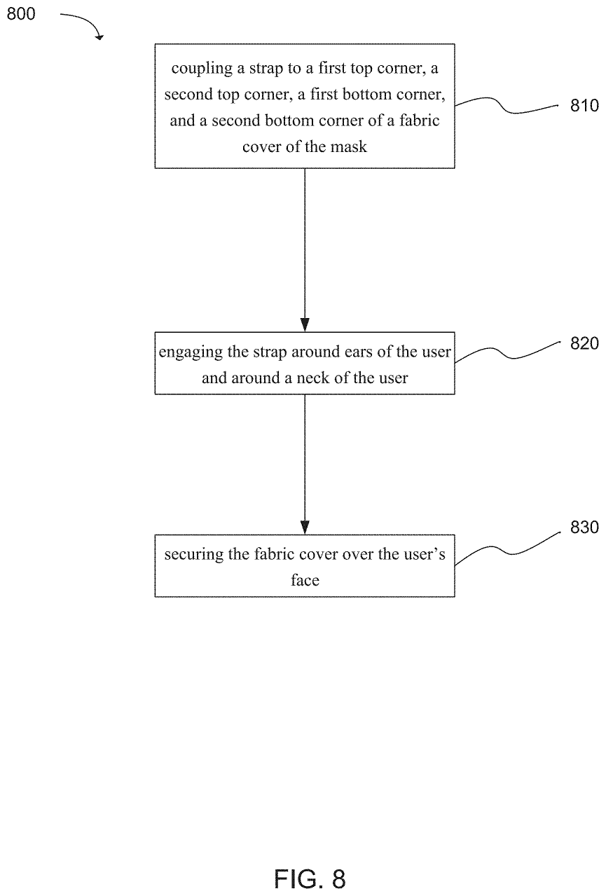

Another example provides a method 800 of securing a mask over a user's face, as shown in the flow chart in FIG. 8. The method can comprise coupling a strap to a first top corner, a second top corner, a first bottom corner, and a second bottom corner of a fabric cover of the mask, as in block 810. The method can comprise engaging the strap around ears of the user and around a neck of the user, as in block 820. The method can comprise securing the fabric cover over the user's face, as in block 830.

In one aspect, the method can include engaging a first portion of the strap around a first ear of the user, engaging a second portion of the strap around a second ear of the user, and engaging a middle portion of the strap around the neck of the user. In another aspect, the method can include hanging the mask from the neck of the user by the middle portion of the strap when: the first portion of the strap is not engaged around the first ear of the user, the second portion of the strap is not engaged around the second ear of the user, and the middle portion of the strap is engaged around the neck of the user. In another aspect, the method can include engaging the strap around the ears of the user by looping around the ears of the user, and adjusting a length of the strap around the ears of the user.

In another aspect, the method can include movably engaging the first portion of the strap with the first bottom corner using a first retainer, or movably engaging the second portion of the strap with the second bottom corner using a second retainer, or movably engaging the third portion of the strap with each of the first bottom corner and the second bottom corner using the first retainer and the second retainer. In one aspect, the method can include filtering pathogens that are physically proximate to the user.

In yet another aspect, the method can comprise transitioning the fabric cover from a covering orientation (e.g., covering a nose, a mouth, or both of a user) to a hanging orientation (e.g., hanging around a neck of the user without covering the nose, the mouth, or both of the user) when a first portion of the strap is removed from a first ear of the user and the second portion of the strap is removed from the second ear of the user.

In yet another aspect, the method can comprise transitioning the fabric cover from a hanging orientation (e.g., hanging around a neck of the user without covering the nose, the mouth, or both of the user) to a covering orientation (e.g., covering a nose, a mouth, or both of a user) when a first portion of the strap is engaged around a first ear of the user and a second portion of the strap is engaged around a second ear of the user.

What is claimed is:

1. A face mask comprising:
a fabric cover operable to engage at least a portion of a user's face, wherein the fabric cover comprises:
a first top corner and a second top corner,
a first bottom corner and a second bottom corner, and
an inner surface and an outer surface; and
a strap operable to engage the fabric cover over the portion of the user's face, wherein:
the strap is coupled to the first top corner and the second top corner,
the strap is coupled to the first bottom corner and the second bottom corner, and
the strap is operable to engage around ears of the user and around a neck of the user.

2. The face mask of claim 1, wherein the strap comprises:
a first portion, fixedly attached to the first top corner and engaged to the first bottom corner, and operable to engage around a first ear of the user;
a second portion, fixedly attached to the second top corner and engaged to the second bottom corner, and operable to engage around a second ear of the user; and
a middle portion, engaged to the first bottom corner and the second bottom corner, and operable to engage around the neck of the user.

3. The face mask of claim 2, wherein the face mask is operable to hang from the neck of the user by the middle portion of the strap when:
the first portion of the strap is not engaged around the first ear of the user,
the second portion of the strap is not engaged around the second ear of the user, and
the middle portion of the strap is engaged around the neck of the user.

4. The face mask of claim 2, wherein:
the first portion of the strap is movably engaged with the first bottom corner using a first retainer; and
the second portion of the strap is movable engaged with the second bottom corner using a second retainer; and
a middle portion of the strap is movably engaged with each of the first bottom corner and the second bottom corner using the first retainer and the second retainer.

5. The face mask of claim 1, wherein the first retainer comprises a first loop and the second retainer comprises a second loop.

6. The face mask of claim 1, wherein the fabric cover further comprises an antimicrobial material including one or more of: silver-infused fabrics, silver compound infused fabrics, silver-oxide infused fabrics, zinc-oxide infused fabrics, titanium dioxide infused fabrics, aluminum infused fabrics, aluminum oxide infused fabrics, copper infused fabrics, copper oxide infused fabrics, and combinations thereof

7. The face mask of claim 1, wherein the strap is operable to engage around the ears of the user by looping around the ears of the user, and the length of the strap is operable to be adjusted around the ears of the user.

8. The face mask of claim 1, wherein the fabric cover comprises a plurality of layers.

9. The face mask of claim 1, wherein the fabric cover further comprises a pliable material that is operable to retain a shape that seals around a bridge of a nose of the user.

10. The face mask of claim 1, further comprising a filter configured to filter pathogens that are physically proximate to the user.

11. The face mask of claim 1, wherein the strap comprises an elastic material that flexibly accommodates the ears and neck of the user.

12. The face mask of claim 1, wherein the strap is an integrated material.

13. The face mask of claim 1, wherein the fabric cover is operable to transition from a covering orientation to a hanging orientation when a first portion of the strap is removed from a first ear of the user and a second portion of the strap is removed from a second ear of the user.

14. The face mask of claim 1, wherein the fabric cover is operable to transition from a hanging orientation to a covering orientation when a first portion of the strap is engaged around a first ear of the user and a second portion of the strap is engaged around a second ear of the user.

15. The face mask of claim 1, wherein the fabric cover is operable to:
cover a nose and a mouth of the user when the fabric cover is in a covering orientation; and
hang around a neck of the user without covering the nose and the mouth of the user when the fabric cover is in a hanging orientation.

16. A method of securing a mask over a user's face comprising:
coupling a strap to a first top corner, a second top corner, a first bottom corner, and a second bottom corner of a fabric cover of the mask; and
engaging the strap around ears of the user and around a neck of the user; and
securing the fabric cover over the user's face.

17. The method of claim 16, further comprising:
engaging a first portion of the strap around a first ear of the user;
engaging a second portion of the strap around a second ear of the user; and
engaging a middle portion of the strap around the neck of the user.

18. The method of claim 17, further comprising:
hanging the mask from the neck of the user by the middle portion of the strap when:
the first portion of the strap is not engaged around the first ear of the user,
the second portion of the strap is not engaged around the second ear of the user, and
the middle portion of the strap is engaged around the neck of the user.

19. The method of claim 17, further comprising:
movably engaging the first portion of the strap with the first bottom corner using a first retainer;
movably engaging the second portion of the strap with the second bottom corner using a second retainer; and
movably engaging the third portion of the strap with each of the first bottom corner and the second bottom corner using the first retainer and the second retainer.

20. The method of claim 16, further comprising:
engaging the strap around the ears of the user by looping around the ears of the user, and
adjusting a length of the strap around the ears of the user.

21. The method of claim 16, further comprising
filtering pathogens that are physically proximate to the user.

22. The method of claim 16, further comprising:
transitioning the fabric cover from a covering orientation to a hanging orientation when a first portion of the strap is removed from a first ear of the user and a second portion of the strap is removed from a second ear of the user.

23. The method of claim 16, further comprising:
transitioning the fabric cover from a hanging orientation to a covering orientation when a first portion of the strap is engaged around a first ear of the user and a second portion of the strap is engaged around a second ear of the user.

24. The method of claim 16, further comprising:
covering a nose and a mouth of the user when the fabric cover is in a covering orientation; and
hanging around the neck of the user without covering the nose and the mouth of the user when the fabric cover is in a hanging orientation.

25. A face mask comprising:
a fabric cover operable to engage at least a portion of a user's face, wherein the fabric cover comprises:
a first top corner and a second top corner,
a first bottom corner and a second bottom corner,
an inner surface including a pocket operable to retain a filter;
an antimicrobial material including one or more of: silver-infused fabrics, silver compound infused fabrics, silver-oxide infused fabrics, zinc-oxide infused fabrics, titanium dioxide infused fabrics, aluminum infused fabrics, aluminum oxide infused fabrics, copper infused fabrics, copper oxide infused fabrics, and combinations thereof; and
an outer surface; and
one or more straps operable to engage the fabric cover over the portion of the user's face.

26. The face mask of claim 25, wherein the one or more straps includes a first strap, wherein:
the first strap is fixedly attached to the first top corner and the second top corner,
the first strap is engaged to the first bottom corner and the second bottom corner, and
the first strap is operable to engage around ears of the user and around a neck of the user.
